(19) United States
(12) Patent Application Publication
(10) Pub. No.: US 2017/0073794 A1
(43) Pub. Date: Mar. 16, 2017

(54) Recovery of Metals from Ores

(71) Applicant: NOVEL MINING LIMITED, Auckland (NZ)

(72) Inventors: Peter Marino Pavlovich, Te Atatu South (NZ); Craig Rothwell Hughes, Tolga (AU); Brendan Allan Woodley, Kilmore (AU)

(21) Appl. No.: 15/358,647

(22) Filed: Nov. 22, 2016

Related U.S. Application Data
(63) Continuation of application No. 14/349,042, filed on Apr. 1, 2014.

(30) Foreign Application Priority Data
Oct. 4, 2011 (AU) 2011904089

(51) Int. Cl. C22B 3/00; C01B 13/10; C22B 3/20; C22B 3/10; C22B 3/14

(52) U.S. Cl. CPC C22B 11/04; C22B 3/10; C22B 3/14; C22B 3/20; C01B 13/10

(57) ABSTRACT

A process includes at least formulating an aqueous oxidizing solution by addition of ingredients to water, wherein the aqueous oxidizing solution has a pH of less than 0.7 primarily from at least one strong acid, at between 0.04% and 0.42% weight/volume of persulphate anions, and 0.03% to 0.1% weight/volume of hydrogen peroxide; an irradiation step wherein ozone is produced by irradiating oxygen with an ultraviolet source wherein the ozone is present in the solution at a concentration of 0.75 to 2 mg/L ozone; a metal solubilization step of oxidizing and thereby rendering soluble a desired at least one metal from a ground amount of ore in suspension; collecting a pregnant liquor from the suspension; and selectively removing at least a portion of the at least one metal from the liquor while at a pH of less than 3, such that any remaining liquid is a recyclable liquor.

### CROSS-REFERENCE TO RELATED APPLICATIONS

This Application is a continuation of U.S. patent application Ser. No. 14/349,042, entitled “Recovery of Metals from Ores,” filed on Apr. 1, 2014, which is a Section 371 National Stage Application of International Application No. PCT/AU2012/001201, filed Oct. 4, 2012 and published as WO 2013/049886 on Apr. 11, 2013, in English, the contents of which are hereby incorporated by reference in their entirety.

### FIELD

The invention relates to cyanide-free and mercury-free aqueous chemical processes and solutions for the recovery of metals, including precious or noble metals, copper, zinc and other metals from ores or other sources including rubbish, tailings and mullock.

Definitions

The oxidation potential (with respect to a standard hydrogen electrode) of various materials is described herein as Eₕ, given in volts.

“Ore” includes without limitation carbonaceous (carbonate) ores, sulphide ores, porphyry ores, massive metal such as in quartz ores, selected industrial waste such as electronic parts, and tailings and mullock.

### BACKGROUND

In history, much human effort has been devoted to finding and collecting gold which apart from its presently rising market value has many valuable properties, including electrical, visual and chemical attributes. Gold is recovered from ores or deposits as the native metal, using processes based on its high density and lack of reactivity.

The inventors note that there is a wide variety of circumstances under which an aqueous extraction of gold might be applied. Ores can be described as for example sulphide ores, carbonaceous ores, porphyrys, quartz veins, and alluvial gold; the latter two may include visible lumps of native metal. Some industrial waste includes gold—such as gold plated electronic parts. Although older mining literature focuses on visible particles of free gold there is an increasing interest in “insensible gold” which may be colloidal, chelated, exist as a compound, or be simply too small to see. In the literature several instances are known (e.g. van Antwerp) where the amount of gold actually recovered is substantially in excess of the amount indicated for a sample by a traditional “fire assay” method. The inventors suspect that existing standardized assays such as “ASTM E1335 Standard Test Method” may not always properly describe the gold present in an ore in relation to advanced recovery processes. An assay method that does not require concentration or extraction but relies on bulk nuclear elemental properties such as X-ray fluorescence, neutron activation, or the like may be required. Solubilisation of ores with cyanide solutions is used frequently for collection of small particles; aqua regia is used less often. Gold can then be precipitated by for example adding zinc or aluminium to the cyanide solution. But the cyanide process is largely incompatible with sulphide ores. Carbon-based, ion-exchange, organic solvent and other methods for recovery of gold are known. Amalgamation with mercury is commonly used. Possible explanations for the sometimes surprising levels of recovery seen in the prior art and in this invention, as compared to indications from chemical assay methods include:

Presence of finely divided metal, even colloidal native metal, “micron gold”,

Alloyed metal,

Existence within chemical compounds (e.g. platinates) or in chelates or titanates or alumina silicates or iron/aluminium silicates or arsenopyrite or gold tellurides,

Chemical assay with an unintentionally low recovery rate,

Interference from other materials during the assay such as high levels of copper.

It should be noted that the improvements to be described in the following specification are useful even if there is a substantial amount of other metals present in an ore, such as copper.

### PRIOR ART

The following citations refer to aqueous extraction of gold from crushed ore under combinations of strong acid (low pH) and high oxidation potential.

Van Antwerp et al (1987) in U.S. Pat. No. 4,642,134 used a combination of a low pH of about 3, in combination with a reduction potential Eₕ in the oxidising solution including ozone, having a potential of no more than 2.4 volts. They state that 2.4 V is at about the upper limit of ultraviolet-generated ozone in solution. (Such a potential is insufficient for some forms of gold). After the gold is oxidized, conventional leaching chemicals are used to recover the gold. Van Antwerp et al (1987) in U.S. Pat. No. 4,752,412 also used activated oxygen/ozone derived from effects of UV light. Note that their preference for acetic acid 1-3% by volume necessarily prevents the pH from being lower than about 3. There was a marked swelling of the ore; however the type of ore is not specified. Note that the Antwerp process (see '134) breaks chemical bonds (col 5 line 40) in an acid environment with bubbled ozone for about 2 hours, then raises the pH of the treated slurry to about pH 11 and then heats it to about 180 deg F. for about another 4 hours while continuing to sparge the slurry with ozone—col 6 lines 1-3. Metal was recovered after neutralization and treatment with leaching chemicals such as cyanide. Significantly more gold was recovered (2.92 oz/ton ore) than was indicated by conventional assay (0.17 oz/ton ore).

Lakshmanan et al in U.S. Pat. No. 4,537,628 used peroxymonosulphuric acid (H₂SO₅ or Caro's acid) to extract gold from arsenic-containing gold ore, followed by a cyanide process. Scheiner et al (1973) in U.S. Pat. No. 3,764,650 a combination of a very low pH of no higher than about 1 and a reduction potential Eₕ of more than 1.4 volts, sodium chloride, sulphuric acid, and ozone in an 8-hour process. Scheiner et al in U.S. Pat. No. 3,574,600 said the ozone was to prevent reabsorbtion of gold, and completed the process with cyanide—after neutralisation. Hansen et al in U.S. Pat. No. 3,545,964 (1970) used a low pH in combination with a reduction potential Eₕ of more than 1.4 volts, and potassium thiocyanate in a 10-day process, reliant on organic solvents. Joseph (US732641) (1903) used an acidic oxidising solution including sulphuric acid, potassium permanganate, nitric acid and sodium hyposulphite and also sodium chloride, with an unspecified leaching process.

Object

An object of the present application is to provide a solution or composition, and a process for recovering metals including noble metals from an ore, or at least to provide the public with a useful choice.

### SUMMARY OF INVENTION

In a first broad aspect the invention provides a cyanide-free and mercury-free aqueous process for recovery of one or more desired metals, including precious metals and other metals from an ore, more particularly wherein the first aspect relates to an aqueous oxidising solution characterised in that the aqueous oxidising solution has a pH of less than 0.7 primarily as a result of the presence of at least one strong acid and a reduction potential (Eₕ) of at least 2.5 V primarily as a result of the presence of persulphate anions and contains anions selected from a group consisting of chloride, bromide, iodide and nitrate ions.

The oxidising solution, when freshly prepared, has a pH of less than 0.7 and a reduction potential Eₕ of at least 2.5 V and the oxidising solution is maintained in an acidic state with a pH of less than 3 throughout the process.

Preferably the oxidising solution includes at least one compound selected from the range of: hydrogen peroxide, and freshly made ozone in solution.

In a related aspect the invention provides an oxidising solution as previously described in this section wherein the solution includes an effective amount of at least one strong acid or mixture of strong acids capable of lowering the pH of the solution to about 0.6 or less, said acid being selected from a range including hydrochloric acid, sulphuric acid, persulphuric acid and nitric acid, and wherein the solution includes a sufficient amount of an oxidizing agent selected from a range including without limitation one or more of the oxidising salts potassium peroxymonosulphate KHSO₅ (CAS 10361-76-9), sodium persulphate Na₂S₂O₈, (CAS 7775-27-1) and ammonium persulphate (NH₄)₂S₂O₈, CAS 7727-54-0), together with the oxidising agent hydrogen peroxide, such that the reduction potential is at least 2.5 Eₕ.

Preferably the solution includes a halide salt selected from a range including sodium chloride, potassium chloride, sodium bromide or potassium bromide.

For commercial efficacy, in one embodiment, the aqueous oxidizing solution includes at least the following ingredients:
a) 3-10% by weight of hydrochloric acid;
b) 0.05 to 2% of a persulphate selected from the group consisting of sodium persulphate potassium persulphate and ammonium persulphate;
c) 0.1-0.3% by volume of commercial strength (30%) hydrogen peroxide;
d) ozone in an amount of about 0.5 to 1 mg/litre made by ultraviolet irradiation of oxygen; and
e) the remainder being water.

In one example, the oxidising solution includes 8.4% by volume of concentrated hydrochloric acid, 0.09% by weight of sodium persulphate or ammonium persulphate, 0.18% by weight of sodium bromide, 0.16% by volume of commercial strength hydrogen peroxide, ozone at about 0.75 mg/litre made by ultraviolet irradiation of oxygen, and water.

Preferably the oxidizing potential (Eₕ) of the solution is capable of reaching about 2.8 V.

In a second broad aspect the invention provides a process for using the aqueous oxidising solution as claimed in any one of claims 1 to 5, characterised in that the process includes a first formulation step of formulating the aqueous oxidising solution by addition of ingredients to water, a second metal solubilisation step of oxidising and thereby rendering soluble a desired at least one metal from a ground amount of ore in suspension, a third collecting step of collecting a pregnant liquor from the suspension, a fourth metal extraction step of selectively removing at least a portion of the at least one metal from the liquor while at a pH of less than 3; such that any remaining liquid is a recyclable liquor.

Preferably, process is adapted for recycling of the solution by maintaining the oxidising solution with a pH of less than about 3 at all times.

Further preferably, the process includes a first stage of forming the acidic, oxidising solution by addition of ingredients to water in a tank, a second stage of leaching the desired metal or metals from a ground aliquot of ore in suspension in another tank, a third stage of collecting a pregnant liquor from the suspension into yet another tank, a fourth stage of selectively removing the desired metal or metals from the liquor while at a pH of less than 3, thereby creating a recyclable liquor, and a fifth stage of holding the recyclable liquor in a tank ready for re-use.

In a related aspect the process divorces a first process of leaching of the ore from a second process of recovery of the desired one or more metals by providing a storage tank for holding pregnant liquor prior to metal extraction, and a second storage tank for holding recyclable liquor after metal extraction, from which it may be recycled into a substantially original state by addition of those ingredients that have been consumed.

Optionally, the method provides a plurality of paths for separate extraction of more than one metal from the same ore in a series of steps; each path including a storage tank for holding pregnant liquor prior to metal extraction, and a second storage tank for holding recyclable liquor after metal extraction, wherein the pH of the oxidising solution is reduced and the reduction potential is increased with each succeeding step.

Optionally the same charge of ore is re-exposed to one or more further batches of fresh or restored solution until a test discloses that an amount of recovered metal in the suspension is no longer adequate and the ore is discarded.

In a further option the ozone is also added to the solution during a leaching procedure and recirculates the solution past a source of ultraviolet light at or about 254 nm wavelength during the solubilising process, thereby causing reactions to occur that release oxidising radicals including without limit the oxygen singlet and ozone radical.

Preferably the source material or ore is finely ground, so that it will remain suspended as fine particles in the aqueous solution while being recirculated and so that the reaction rate is not unduly slowed.

A preferred period of time for oxidising a batch of the suspension of at least carbonaceous and porphyry-based ore is between 5 and 120 minutes at ambient temperature; alternatively ores not finely ground or of recalcitrant types may require exposure for up to about 3 weeks.

One preferred method for extracting said at least one metal from the pregnant liquor comprises passing the pregnant liquor which has a pH of less than about 3 through a series of selective electrolysis cells or electrowinning cells.

### PREFERRED EMBODIMENT

The description of the invention to be provided herein is given purely by way of example and is not to be taken in any way as limiting the scope or extent of the invention. Please note that, although this invention was originally developed for use in the recovery of gold from finely divided forms in ore bodies, it has become apparent that other noble metals, including platinum, palladium, ruthenium, rhenium, iridium and osmium, other valuable metals including copper and silver, and other elements including at least some of the rare earths useful for example in phosphors and for permanent magnets either have been or are likely to be recoverable in economic quantities from selected ore bodies. Nevertheless the discussion dwells on gold, the characteristics of which present the greatest challenge in terms of reaching a suitable oxidation potential.

Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps. Each document, reference, patent application or patent cited in this text is expressly incorporated herein in their entirety by reference. Reference to cited material or information cited in the text should not be understood as a concession that the material or information was part of the common general knowledge or was known in Australia or in any other country.

### DRAWINGS

FIG. 1: Outline of a single-path recirculating processing plant, according to the present invention.

FIG. 2: Outline of a multi-path recirculating processing plant, according to the present invention.

FIG. 3: Outline diagram of a processing plant including direct photochemical oxidation of the liquid, according to the present invention.

FIG. 4: Outline of a multi-step recirculating processing plant, according to the present invention.

### THEORY

The present invention provides solutions each having a composition that provides conditions capable of solubilising gold (or other desired metals) in a variety of types of ore. Problems with implementation of this discovery include keeping the ionized metals in solution until it is brought to a reclaiming step in a process and there is reclaimed efficiently. Halide ions—chloride, bromide or iodide—are used to assist this purpose, particularly with gold. The inventors do not assert that this explanations or their theories are correct or complete, and note that the chemistry of strong oxidising solutions especially in combination with ozone and ultraviolet light is not well established.

Practice:

The invention provides an oxidising solution and a process for use in the recovery of one or more metals, such as, but not limited to gold from an ore as defined above. The solution comprises variants of an acidic aqueous solution including hydrogen, chloride and bromide ions and strong oxidants including peroxydisulphate or persulphate ions, ozone, and hydrogen peroxide. The initial oxidising power of this solution is maintained during treatment of a batch of ore by mixing externally, freshly generated ozone supplied from generator 109 either before, or during suspension while it is being agitated inside reaction vessel 101. When recycling the oxidising solution, its pH and Eₕ are restored by addition of reagents.

The inventors have observed that adding a small amount of ozone to the solution before a leaching process, such as 0.75 g of ozone, causes the amount of recoverable gold in the supernatant to rise up to a usefully recoverable amount in a few minutes, whereas if the ozone is not added, the gold concentration may take a week or longer to rise by the same amount. This effect occurs despite the presence of persulphate but is, of course, dependent on the ore and particle sizes in the suspension.

It is believed that hydroxyl radicals are generated by reactions between ozone and hydrogen peroxide. This type of mixture is also known as “peroxone”. The presence of hydrogen peroxide shortens the half-life of ozone. The “oxidising strength” of the hydroxyl radical (as OH+e⁻>OH⁻) is +2.8V Eₕ, a little less than that of fluorine. The inventors have not yet explored uses and advantages of various types of ozone radicals. The oxidising capacity of the preferred persulphate radical is almost as high, at 2.7 V Eₕ, as the hydroxyl radical.

### EXAMPLE 1

### Batch Plant Layout; One Track

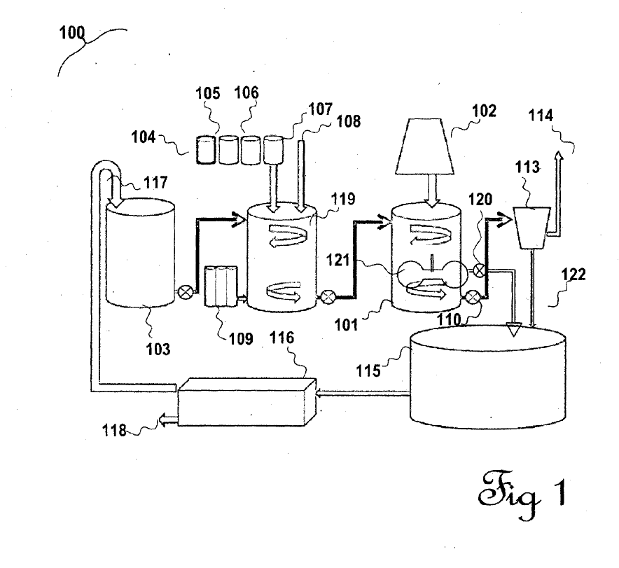

Refer to the plant 100 in FIG. 1. Ore enters the process at mill 102 and leaves the process, optionally to be recycled, at exit 114 after separation in a hydrocyclone 113. Liquid is recycled through the four connected tanks. 101 is the stirrable reaction tank, 103 holds recyclable liquid for re-use, 119 is a tank used for mixing fresh batches of the oxidising solution or for rejuvenating recycled solution (recyclable liquid) and 115 is a tank for holding pregnant liquors for separation of recovered metals (if present) within separating means 116. The tanks may be made of steel or stainless steel, preferably coated with a paint or other polymer. Alternatively, plastics materials may be used. Polypropylene is suitable.

In order to commence a new batch, water 108, optionally existing recyclable liquid 103, and reagents 104, 105, 106, 107 (see list below) and ozone from the gas generator 109 are placed in tank 119, and thoroughly stirred as indicated by the curved arrows. This liquid, which has a pH of around 0.6 and is strongly oxidising, is transferred to tank 101. An amount of ore which has been ground to a suitably fine size in mill 102; for example such that 95% passes a 0.1 mm diameter sieve is added to tank 101 such that a suspension is formed in the oxidising solution without any caking. The slurry preferably holds at least 5-10% by weight of ore (the pulp ratio), although this amount may depend on the particular ore being processed. An internal agitator 121 (motor not shown) maintains the slurry in suspension.

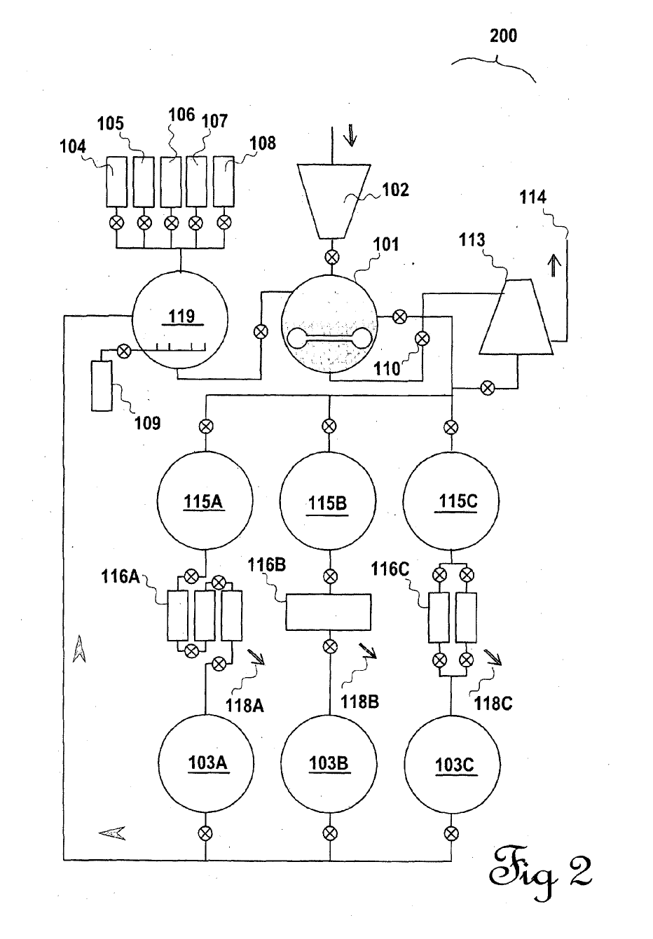

This diagram is simplified in that leaching tank 101 may in fact comprise a series of such tanks, or an elongated trough, preferably including mixing means. A graded series of solutions may be used, optionally followed by a leaching time. (See also Example 2.) In relation to the relatively short path taken by the ground ore as shown in FIG. 2 (102-114), it should be noted that inclusion of ozone greatly speeds the process. An extraction that might have taken a week without ozone may be substantially complete in a few minutes, though this depends on the ore. But if metallic gold is present, the “etching rate” may be slow using any solution.

It will be appreciated that a quick throughput is economically useful. It should be noted that the process is indefinitely scalable. Throughput is dependent on operating factors. Assuming a 1000 litre (1 tonne) reaction tank and 10% (by weight) of ground ore in the reaction tank for either 10 minutes or 2 hours; to use two arbitrary times, a range between 600 kg and 50 kg of ore per hour may be processed. The metal extraction step or steps should be scaled so as to keep up with the supply of pregnant liquor.

Leaching efficacy may be determined by repeatedly sampling the suspension and testing for solubilised gold ions (or other metals of interest) with a suitable test device such as an atomic absorbtion spectrophotometer (Varian Associates) or an inductively coupled or a microwave-generated plasma discharge device plus spectrograph, or a mass spectrograph, as known to those skilled in the art.

After an appropriate leaching time, pregnant liquor is withdrawn for metal extraction. The plant provides for two methods for removal. In the first or interrupted mode, the agitator paddle 121 is stopped and after a settling period a side port 120 in leaching tank 101 located at position (A) as shown in FIG. 2, placed so as to be a little above the level of the settled charge of ore, is opened so that nearly all of the supernatant will flow through pipe 122 into the tank 115, for receiving pregnant liquor. Then port 120 is closed and another oxidising solution (which may be a different solution—see Example 2) is admitted from preparation tank 119 and agitation of the same batch of ore recommences.

In the second or on-completion mode, the agitator paddle within reaction tank 101 is kept running while the suspension is entirely removed through valve 110 to hydrocyclone 113; the pregnant liquor is drained into tank 115 and the separated, exhausted solids 114 are then discarded into a tailings dam or the like. Further solution is admitted into tank 101 from tank 119 so that the agitator does not run dry. Preferably all remaining acidity in the tailings emitted at 114 is neutralised with ground limestone, phosphate rock or the like, for the sake of the environment. Recyclable liquor is likewise neutralised if discarded. The astute reader will note that exact duration and replenishments are not prescribed since different metals and different ores may need different times.

The pregnant liquor now stored in tank 115 typically now has a pH of up to about 2 to 3. That is, the hydrogen ions of the acid have been partially consumed. The pregnant liquor held in tank 115 is passed through preferably a selected differential metal extraction means 116. The rate of flow through the extraction means is not tied to the rate of flow through the reaction vessel 101, and the metal extraction means may be kept running continuously from pregnant liquor held in tank 115 even while the next batch of suspended ore is being exposed to the solution.

One preferred extraction means 116, which is well known to those skilled in the art of extractive metallurgy, involves selective electrolysis or electrowinning A series of individual electrolytic cells, arranged in a series according to threshold conditions such as the potential applied within and/or the current density per unit area of the cathode is capable of recovering one or more relatively pure metals 118 on separate sets of electrolysis plates (not shown). Equipment for carrying out selective electrowinning metals such as aluminium, cobalt, copper, lead, precious metals and rare earth metals is commercially available from many suppliers such as Electrometals Technologies Limited, Brisbane Australia. The remaining acidic and likely re-usable oxidising liquid, now termed a “recyclable solution” is pumped into tank 103 at 117 to await appropriate supplementation from stocks of specific items based on test results, and then re-use. Given that there may be a variety of specific solutions in use at one time for recovering different metals, each solution may be routed to its own holding and replenishment tanks.

Of course the oxidising solution does not require to be replenished. A fresh solution may be prepared for each extraction. Recycling should be more economical.

Another extraction means well known to those skilled in the relevant arts employs adsorbtion of the gold on to activated carbon 116, then stripping the gold from the carbon and processing the gold after several steps into relatively impure metal bars called Dore bars. Further options at 116 for metal recovery include the already well-known chemical and electrochemical techniques in common use in the mining industry. The recyclable liquor returned to tank 103 may still have a low pH typically 2-3. On return to the mixing tank 103, supplementary amounts of reagents 104, 105, 106, 107 are added in order to make up any losses, for instance to overcome a rise in pH.

Acidic, highly oxidising solutions are employed in order to maximise the extraction of preferred metals such as gold and maintain it in ionic form stabilised by means of chloride or other halide ions, oxidising conditions and a low pH. Although it will be clear to a skilled addressee that exact amounts are not limiting as to the scope of the invention in that the oxidising solution may be varied according to ore type for example, a starting point and a suggested range for such solutions is as follows.

| Example 1 - An oxidising solution | Typical | | Range | |
|---|---|---|---|---|
| Hydrochloric Acid, commercial | 84 | litres | 30-100 | litres |
| conc. | | | | |
| Sodium persulphate Na₂S₂O₈, | 0.9 | kg | 0.5-2 | kg |
| (CAS 7775-27-1) or 0.8 kg | | | | |
| ammonium persulphate | | | | |
| (NH₄)₂S₂O₈ (CAS 7727-54-0), | | | | |
| or 1 kg potassium persulphate, | | | | |
| Sodium Bromide (or potassium | 1.8 | kg | 0 to 3 | kg |
| bromide) | | | | |
| Hydrogen Peroxide, commercial | 1.6 | litres | 0 to 2 | litres |
| strength (about 30%) | | | | |
| Ozone | about 0.75 gram | | 0.3 to 2 | grams |
| Water to make up: | 1000 | litres | | |

The ozone is manufactured on site by irradiating air with ultra-violet light at about 184 or 254 nm, using for example low pressure mercury lamps in quartz or other envelopes, or deuterium or xenon lamps, and bubbling the gas into the mixing tank 119. The pH is about 0.6 and the Eₕ is preferably up to 2.8 V.

The bromide may be optional given that some other halide, namely chloride ions are provided by the hydrochloric acid, although it is known that gold bromide and gold iodide are stable. Further experimentation and trials with different ores may uncover more precise formulations.

Results

In one test, based on analysis by ICPMS (inductively coupled plasma mass spectrograph, 450 grams of gold per ton of ore was extracted by the above plant, solution and method. A conventional analysis of the same ore sample indicated that only 45 grams per ton would be present, and if one allows for 30% recovery rate, that ore would at today's prices have been deemed to be an uneconomic ore for processing. Further trials are as follows.

| | | | Historic | | | | |
|---|---|---|---|---|---|---|---|
| | Historical | | recovered | | | | No. |
| Origin of Ore | head grade | | grade | Average | Highest | | tests |
| Forsyth. Flying | 10-40 | ppm | 15 | 20 ppm | 48 | ppm | 7 |
| [symbol] | | | | | | | |
| Qld Quarry 1 | 100 | ppm | 25 | 45 ppm | 85 | ppm | 13 |
| General Grant | 10 | ppm | 5 | 30 ppm | 55 | ppm | 7 |
| Bathanga | 1.5-2.5 | ppm | 2 | 5 ppm | 8 | ppm | 4 |
| Rutherglen | [symbol] .2-2.0 | ppm | 0.2 | 3 ppm | 70 | ppm | 8 |
| Nuggety gully | unknown | | | | 5.0 | ppm | 1 |
| Palmer River | [symbol] .2-2.0 | ppm | 0.2 | | 5.0 | ppm | 1 |
| Morning Star | 2.5-5.0 | ppm | 2 | | Zero | | 1 |
| | | | | | recovery | | |
| Greenvale | 2.0-5.0 | ppm | 2 | | 4.0 | ppm | 1 |

[symbol]

indicates data missing or illegible when filed

### EXAMPLE 2

### Recirculating Batch Plant Layout

See FIG. 2. This layout 200 extends the principles shown in FIG. 1 and includes a parallel set of processes. In this example, three sets of metal extraction lines, such as for copper (A), silver (B) and gold (C) and their associated tanks are supplied with an oxidising solution from a single set of a mixing tank 119 and a reaction tank 101 (which is shown with the slurry settled and a supernatant ready to be drawn by selective operation of valves into an appropriate metal extraction line). There is again a single path for ore, from ore mill 102 to the output 114 of spent ore from a hydrocyclone 113. The ore is exposed to more and more active aqueous solutions in a planned sequence.

The preferred way to use a plant constructed according to this layout is to treat a mixed ore, which might for example contain copper, zinc, and gold, in a sequence, with each subsequent stage applying a higher reduction potential Eₕ and a lower pH within the oxidising solution so that the most easily oxidised or solubilised metal is removed first from the ore and is then diverted into a particular stream (A, B or C) appropriate for extraction of that metal. This has the advantage that the more expensive and more active oxidising agents are spared from initial treatment of the ore, and of maximising the extraction efficiency within each metal extraction device.

Each of the “A” stream, “B” stream and “C” streams that include corresponding pregnant liquor tanks 115A or 115B or 115C, appropriate metal extraction devices 116A or 116B or 116C, and recyclable liquid tanks 103A, 103B and 103C operate with a different chemical solution, as made up in the single mixing tank 119 from supply tanks 104, 105, 106, 107 and 108. Each stream stays relatively separate so long as the relevant valves are correctly controlled, and is not mixed with other streams. Alternatively a single mix can be used several times over in a sequence C then B then A as its acidity and reduction potential decline with use. Solution 1 (which itself is not a definitive prescription) may be modified as follows in relation to each particular type of ore and metals to be extracted, for instance
a) Less hydrochloric acid, for a pH of more than 0.6,
b) less or more sodium persulphate,
c) less ozone, and
d) less hydrogen peroxide, for an Eₕ less than about 2.5.

Note that the different oxidising agents named above have different chemical properties, and different effects. For example, the inventors have repeatedly observed that included ozone makes otherwise slow reactions run to substantial completion within minutes, rather than days if the ozone is omitted.

As a result, each metal extraction device 116A or B or C may be optimised for a particular metal, such as by employing different electrowinning sets or, for any one metal, a series of chemical stages optionally including precipitation, centrifugation, filtering, foam separation or the like (as at 116A). The raw metals 118A, 118B and 118C are separate outputs from this separation plant.

Note that all tank sizes are shown as the same size in FIG. 2. In practice tank sizes, and number and type of metal extraction devices would depend on the particular ore being processed. Solubilisation of massive metals may be the slowest phase. Metal extraction can proceed at an independently controlled pace determined by technical limits and amount of metal ions present, for example, drawing pregnant liquor from tank 115A or B or C and returning it to tank 103 A or B or C while slurry extraction proceeds at an independent rate. In a commercial operation, the operation of valves (crossed circles, not labelled for simplicity) and pumps (not shown) may be automated as is well known to a skilled addressee. Liquids in each stream are mixed to a small extent only such as within pipes and by being entrapped within the ore particles, and remain reasonably optimised. The repeatedly applied test and replenishment process used at tank 119 will maintain the required characteristics of each set of liquids.

Silver extraction: since silver halides tend to precipitate (at least around pH 7, Eₕ=0) it may be preferable to use a nitric acid-based set of liquids, excluding hydrochloric acid and halide salts within one channel (such as the “B” channel starting at 115B), noting that nitric acid is itself an oxidiser. The inventors have noted a reasonably good recovery of silver in their chloride/bromide process at low pH and relatively high reduction potential, although silver ions may tend to be adsorbed on to the ore slurry and lost. A decision to use a nitric acid process might be based on economics. If halide contamination is a significant adverse effect on recovery, the silver extraction could comprise a pre-treatment of the ground ore.

For copper extraction only, the pH and reduction potential of the oxidising solution may be substantially reduced (En 0.4V to 1V, pH less than about 5) and the same plant may be used without the ozone.

The overall inputs into this Recirculating Batch Plant are ore, reagents including water (104-108) and energy for grinding, pumps, agitators and metal extraction. No heat is required. All operations occur at ambient temperature. Acid is consumed and needs replenishment at each pass, depending on the ore type. The outputs are neutralised, spent ore (at 114), and extracted metals (118A, B and C). From time to time it may be necessary to reject recycled recyclable liquid, which will be salty and acidic and which may have accumulated toxic materials such as arsenic. Such contaminants must be dealt with in order to avoid environmental pollution and breach of relevant laws. More or less than the 3 streams (A, B and C) shown may be used.

### EXAMPLE 3

### Recirculating Ozonising Batch Plant Layout

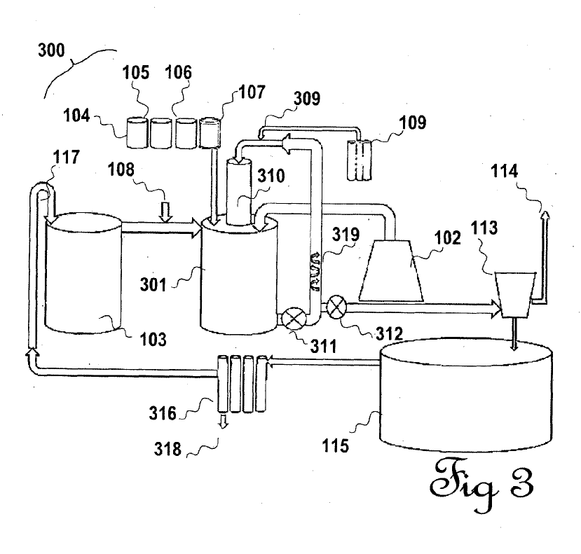

This Example, shown in FIG. 3, differs from Example 1 mainly in that instead of stirring a slurry mixed with a single charge of ozonised solution, the slurry during leaching is repeatedly pumped from tank 301 by diaphragm pump 311 through a mixing tube 319, past an ozone entry port 309, and then past a battery of ultraviolet lamps 310 so that the ozone is repeatedly refreshed and maintained at a high level, until experience, or on-line tests indicate that solubilisation of the desired metals is substantially complete. Shearing or mixing tube 319 subjects the particles of the suspension to shear forces, helping to ensure that the suspended particles (at a low pulp ratio) remain free of any accretion at a microscopic level. Example shearing or mixing tubes containing a series of deflection vanes which force the suspension to change direction repeatedly. Such tubes are well known in the relevant arts.

The stirred output passes an optional entry port for injecting freshly prepared ozone gas from the ozone generator 109. In a version using a 500 litre charge, an ozone generator capable of producing 6 grams of ozone per hour was used. The ozone may be generated by exposure of air or oxygen to an ultraviolet lamp, including low pressure mercury, deuterium or xenon lamps equipped with quartz envelopes, or by exposure to a spark or a radio frequency arc.

Next the suspension is allowed to flow downwards through an ultraviolet exposure means or “reactor” 310 comprising a circular array of typically 6 low-pressure mercury vapour lamps having the same configuration as 1200 mm or 1500 mm long 40 watt fluorescent lamps, but with quartz envelopes, so that the suspension is directly irradiated with ultraviolet light. The electrical connections to the lamps are of course sealed from contamination with liquid. This treatment has the effect of further raising the oxidation potential of the active components of the aqueous mixture by direct interaction of ultraviolet photons with the active components. Hydroxyl radicals are made. The problem of a short half-life of the most active oxidising species is overcome. The combination of the recycling pump 311 and a relatively low “pulp ratio” of suspended ore helps ensure that the suspension remains evenly distributed within the tank 401 during processing, although an internal agitator may also be included.

After a sufficient length of time typically from 1 to 24 hours, depending on the chemical and physical nature of the ore and the mean particle size, the batch is drawn out of the processing tank 301 by activating the pump or valve 312 and shifting the suspension across to a solids separation means 113, such as a dewatering hydrocyclone. The pregnant liquor which now preferably includes an amount of gold in ionic form stabilised by means of chloride anions, oxidising conditions and a low pH is transferred to tank 115 while the solid waste or tailings 114 is disposed of as described in Example 1.

The liquid in tank 415 is passed through a gold extraction means. One of several extraction means that are well known to those skilled in the relevant arts employs adsorbtion of the gold on to activated carbon 316, then stripping the gold from the carbon and processing the gold after several steps into relatively impure metal bars called Dore bars, a standard industry term allowing for the likely co-presence of other metals such as silver.

The remaining acidic and re-usable liquid, now termed a “recyclable solution” is pumped into tank 303 through pipe 117 to await optional supplementation and then re-use. Preferably the recyclable solution is tested for pH, halide ion concentration, and redox potential in order to determine what supplementation is required for restoration of the original solution, as follows.

### Solution for Example 3

| | | |
|---|---|---|
| Hydrochloric Acid, commercial concentrated | 84 | litres |
| Sodium Persulphate | 0.9 | kg |
| Sodium Bromide | 1.8 | kg |
| Hydrogen Peroxide, commercial strength (ca 30%) | 1.6 | litres |
| Water to make up: | 1000 | litres |

All amounts are approximate.

Notes:

1. Potassium or ammonium salts are acceptable substitutes for sodium salts.

2. During use, sufficient suitably finely ground ore, for instance an ore milled to a mean particle size of about 100-150 microns, is added to provide a pulp ratio of 0.5%.

3. During use, ozone is continuously added to the solution from an ozone generator operated beside the apparatus at a rate of about 12 grams per 1000 litres per hour.

RESULTS 1. Samples were assayed for a mine in the Philippines. Some recovered grades are given below. (Note that the common head grade of these samples is almost zero.)

| AGR Matthey Assay No. | Gold Recovery (ppm) |
|---|---|
| 183210 | 312 |
| 183211 | 192 |
| 183212 | 168 |
| 183213 | 732 |
| 183214 | 96 |
| 183215 | 144 |
| 183216 | 164 |
| 183217 | 60 |
| 183198 | 6360 |
| 183199 | 7296 |
| 183200 | 4404 |
| 183201 | 3576 |
| 183202 | 4716 |
| 183203 | 3180 |
| 183204 | 1476 |
| 183205 | 1452 |
| 183206 | 1560 |
| 183207 | 468 |
| 183298 | 72 |
| 183209 | 660 |

2. ALS Chemex analysis. This analysis reported on 3 samples; recovered amount of gold in ppm (method Au-AA25) WK 1: 980, Wk 2: 960 and WK3: 1180 ppm.

### EXAMPLE 4

### Recirculating Batch Plant with Series Metal Extraction

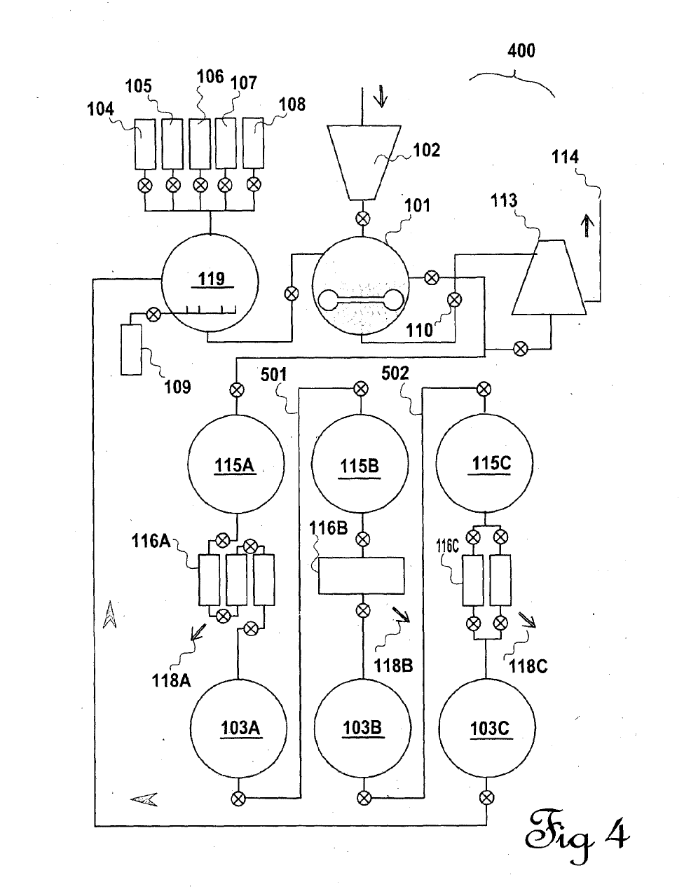

This Example (400 in FIG. 4) differs from Example 2 by applying the highly acidic, high oxidising capacity oxidising solution to the ore in the first instance, and then passing the same pregnant liquor through a series of appropriate metal-specific procedures 116A, 116B and 116C selected, as would be known to a skilled addressee, from a range including electrowinning, chemical precipitation, ion exchange, and active carbon adsorbtion in order to extract (for example) copper, silver, gold, lead, zinc and the like. Each metal-specific procedure is connected in series by conduits 401 and 402. Each metal-specific procedure may optionally be separated from adjacent procedures by a storage tank 115A preceding procedure 116A and another storage tank 103A following procedure 116A in order to allow different rates of processing to be applied.

Advantages

Advantages of the present invention over the prior art can be realised, and at least one of the following advantages will be achieved in appropriate circumstances:
1. The process is able to recover economically useful amounts of gold including from tailings which have previously been processed and discarded as uneconomic;
2. the process recirculates a substantial proportion of its solutions and is more economical and less harmful to the environment;
3. the process separates a leaching flow rate of the oxidising solution applied to the ore from a metal extraction rate or rates;
4. the process is compatible with most types of ore, including carbonaceous ores and porphyry ores, as well as with quartz, and with industrial rubbish such as used printed-circuit boards, electrical connectors and other items carrying gold;
5. in particular the process is substantially immune to the presence of sulphides, unlike existing methods such as cyanide recovery that are difficult to use in the presence of sulphides;
6. the process does not include highly toxic substances such as cyanides, and requires no mercury (except that within lamps);
7. the tailings and waste solutions are amenable to being neutralized with for example added limestone for minimised environmental impact; and
8. the rate of processing of at least some ores is markedly faster.

Finally it will be understood that the scope of this invention as described and/or illustrated herein is not limited to these one or more specific embodiments. Those of skill will appreciate that various modifications, additions, known equivalents, and substitutions are possible without departing from the scope and spirit of the invention as set forth in the following claims.

1. An aqueous oxidizing solution comprising:
a pH of less than 0.7;
at least one strong acid;
between 0.04% and 0.42% weight/volume of persulphate anions;
0.03% to 0.1% weight/volume of hydrogen peroxide; and
between 0.3 and 2 mg/L of ozone.

2. The aqueous oxidizing solution of claim 1, wherein the at least one strong acid is hydrochloric acid, present in a concentration of between 1.0% and 3.4% weight/volume.

3. The aqueous oxidizing solution of claim 1, wherein the hydrogen peroxide is present in a concentration of between 0.048% and 0.06%.

4. The aqueous oxidizing solution of claim 1, further comprising up to 0.3% weight/volume of potassium persulphate.

5. The aqueous oxidizing solution of claim 1, further comprising up to 9.7 mM of halide ions in addition to any halide ions already introduced by the strong acid.

6. The aqueous oxidizing solution of claim 1, further comprising up to 9.7 mM of bromide ions sourced from sodium bromide or potassium bromide.

7. The aqueous oxidizing solution of claim 1, wherein the ozone is generated from exposure to ultraviolet light.

8. The aqueous oxidizing solution of claim 1, comprising:
0.27M-0.92M hydrochloric acid;
0.05%-0.2% of sodium persulphate or ammonium persulphate; and
up to 0.06% hydrogen peroxide

9. A process for using an aqueous oxidizing solution comprising at least steps of:
formulating the aqueous oxidizing solution by addition of ingredients to water, wherein the aqueous oxidizing solution has a pH of less than 0.7 primarily as a result of the presence of at least one strong acid, at between 0.04% and 0.42% weight/volume of persulphate anions, and 0.03% to 0.1% weight/volume of hydrogen peroxide;
an irradiation step wherein ozone is produced by irradiating oxygen with an ultraviolet source capable of producing ozone from oxygen wherein the ozone is present in the aqueous oxidizing solution at a concentration of 0.75 to 2 mg/L ozone;
a metal solubilization step of oxidizing and thereby rendering soluble a desired at least one metal from a ground amount of ore in suspension;
collecting a pregnant liquor from the suspension; and
selectively removing at least a portion of the at least one metal from the liquor while at a pH of less than 3, such that any remaining liquid is a recyclable liquor.

10. The process of claim 9, wherein prior to the metal solubilization step, the ore is ground such that at least 95% of the ground ore can be passed through a 0.1 mm diameter sieve.

11. The process of claim 10, wherein the ground ore is introduced into the solution to arrive at an amount of at least 5% by weight of ore in the suspension.

12. The process of claim 10, wherein the ground ore is introduced into the solution to arrive at an amount of at least 10% by weight of ore in the suspension.

13. The process of claim 9, wherein a pH of the aqueous oxidizing solution is maintained at less than 3 throughout the process; and includes a further step of holding the recyclable liquor ready for return to the formulating step.

14. The process of claim 9, wherein the metal solubilization step takes between 1 and 24 hours to complete.

15. The process of claim 9, wherein a pH of the aqueous oxidizing solution is maintained at less than 3 throughout the process; and further comprises holding the recyclable liquor ready for return to the formulating step; and recycling the recyclable liquor into substantially the aqueous oxidizing solution by addition of those ingredients consumed in the process.

16. The process of claim 9, wherein the irradiation step comprises bubbling ozone into the solution and recirculating the solution past a source of ultraviolet light.
